(19) United States
(12) Patent Application Publication
(10) Pub. No.: US 2024/0340229 A1
(43) Pub. Date: Oct. 10, 2024

(54) REAL-TIME TRANSPORT PROTOCOL HEADER EXTENSION FOR IN-BAND DELAY MEASUREMENT

(71) Applicant: QUALCOMM Incorporated, San Diego, CA (US)

(72) Inventors: Liangping Ma, San Diego, CA (US); Imed Bouazizi, Frisco, TX (US); Bojan Vrcelj, San Diego, CA (US); Lenaig Genevieve Chaponniere, La Jolla, CA (US); Aytac Biber, Carlsbad, CA (US)

(21) Appl. No.: 18/347,977

(22) Filed: Jul. 6, 2023

Related U.S. Application Data
(60) Provisional application No. 63/495,236, filed on Apr. 10, 2023.

(51) Int. Cl. H04L 43/0852; H04L 69/22

(52) U.S. Cl. CPC H04L 43/0858; H04L 69/22

(57) ABSTRACT

Example in-band delay measurement techniques are described. An example first computing device transmits, to a second computing device, a first data packet, the first data packet including a first time indicator and at least one header extension element. The at least one header extension element includes a header extension element header, the header extension element header having a length of at least one byte. The first computing device receives, from the second computing device, a second data packet, the second data packet including a second time indicator. The first computing device determines a data packet delay associated with the first data packet based on the first time indicator and the second time indicator and transmits an indication of the data packet delay to at least one of the second computing device or a third computing device.

This application claims the benefit of U.S. Provisional Patent Application 63/495,236, filed Apr. 10, 2023, the entire content of which is incorporated by reference.

### TECHNICAL FIELD

This disclosure relates to transport of data, such as RTP/SRTP packets.

### BACKGROUND

Applications, such as extended reality (XR) applications, may be accessed by a device over one or more networks from another device. The one or more networks may include wireless wide area network(s), such as a 5G network, wireless local area network(s), such as a Wi-Fi network, the Internet, or the like. As such the end-to-end connection between the two devices may traverse different types of networks. Traversal of networks by a data packet may cause data packet delay.

### SUMMARY

In general, this disclosure describes techniques for improving accuracy of delay measurements. More particularly, this disclosure describes techniques for more accurately determining delay in end-to-end transportation of data packets, such as RTP/SRTP packets. RTP/SRTP packets may include RTP packets and/or SRTP packets. A packet may include a header extension element which may include information relating to a time indicator, such as at least one of an indication of a number of time indicator(s), a start of the time indicator(s), and a location of the time indicator(s), a length of the time indicators in the packet, or a type of the time indicator(s). The header extension element may include a one-byte or two-byte header extension element header, such as the one-byte format or the two-byte format for a RTP header extension element header. The packet may include a timestamp or a delay measurement message which may be contained in the header extension element or in a packet payload.

In one example, a method includes: transmitting, by a first computing device to a second computing device, a first data packet, the first data packet comprising a first time indicator and at least one header extension element, the at least one header extension element comprising a header extension element header, the header extension element header having a length of at least one byte; receiving, by the first computing device from the second computing device, a second data packet, the second data packet comprising a second time indicator; determining, by the first computing device, a data packet delay associated with the first data packet based on the first time indicator and the second time indicator; and transmitting, by the first computing device, an indication of the data packet delay to at least one of the second computing device or a third computing device.

In another example, a method includes: receiving, by a second computing device from a first computing device, a first data packet, the first data packet comprising a first time indicator; and transmitting, by the second computing device to the first computing device, a second data packet, the second data packet comprising a second time indicator, a third time indicator, and at least one header extension element, the at least one header extension element comprising a header extension element header, the header extension element header having a length of at least one byte.

In another example, a first computing device includes a memory configured to store a first data packet; and one or more processors coupled to the memory, the one or more processors being configured to: transmit to a second computing device the first data packet, the first data packet comprising a first time indicator and at least one header extension element, the at least one header extension element comprising a header extension element header, the header extension element header having a length of at least one byte; receive from the second computing device a second data packet, the second data packet comprising a second time indicator; determine a data packet delay associated with the first data packet based at least in part on at least one of the first time indicator or the second time indicator; and transmit an indication of the data packet delay to at least one of the second computing device or a third computing device.

In another example, a second computing device includes a memory configured to store a first data packet; and one or more processors coupled to the memory, the one or more processors being configured to: receive, from a first computing device, a first data packet, the first data packet comprising a first time indicator; and transmit, to the first computing device, a second data packet, the second data packet comprising a second time indicator, a third time indicator, and at least one header extension element, the at least one header extension element comprising a header extension element header, the header extension element header having a length of at least one byte.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example system that implements techniques for streaming media data over a network.

FIG. 1B is a block diagram illustrating another example system that implements techniques for streaming media data over a network.

FIG. 2 is a block diagram illustrating an end-to-end XR system in which data packets traverse more than one network.

FIG. 3 is a conceptual diagram illustrating example delays in an end-to-end connection for an XR application according to one or more aspects of this disclosure.

FIG. 4 is a conceptual diagram illustrating an example RTP/SRTP packet and RTP header extension format (RFC 3550).

FIGS. 5A-5B are conceptual diagrams illustrating example RTP/SRTP packet formats (RFC 8285).

FIG. 6 is a conceptual diagram illustrating an example one-byte format with timestamps in a header extension according to one or more aspects of this disclosure.

FIG. 7 is a conceptual diagram illustrating an example one-byte format with timestamps in a payload according to one or more aspects of this disclosure.

FIG. 8 is a conceptual diagram illustrating an example two-byte format with timestamps in a header extension according to one or more aspects of this disclosure.

FIG. 9 is a conceptual diagram illustrating an example two-byte format with timestamps in a payload according to one or more aspects of this disclosure.

FIG. 10 is a flow diagram illustrating an example data packet delay technique according to one or more aspects of this disclosure.

FIG. 11 is a flow diagram illustrating another example data packet delay technique according to one or more aspects of this disclosure.

### DETAILED DESCRIPTION

In general, this disclosure describes techniques for improving accuracy of delay measurements. More particularly, this disclosure describes techniques for more accurately determining delay in transmission of data packets (data packet delay), such as delay caused in end-to-end transportation of data packets. Such data packets may include and RTP packet or an SRTP packet (referred to herein as an RTP/SRTP packet), where RTP standards for Real-time Transport Protocol and SRTP stands for Secure Real-time Transport Protocol. A packet, such as an RTP/SRTP packet, may include a time indicator, such as a timestamp or a delay measurement message. The packet may also include at least one header extension element. The at least one header extension element may include information relating to the time indicator. A header of the at least one header extension element (which may be referred to herein as a header extension element header) may be of a length of at least one byte, such as being one byte or two bytes in length. In some examples, the time indicator may be in the at least one header extension element. In other examples, the time indicator may be in a payload of the packet.

In extended reality (XR) applications, an end-to-end connection may include both wireless wide area networks, such as 5G networks, and non-wireless wide area networks (e.g., non-5G networks). The non-5G networks may include the Internet, wireless local area networks (e.g., Wi-Fi networks), etc. While the techniques of this disclosure may be applicable to wireless wide area networks other than 5G networks, for the ease of description, a 5G network is used hereinafter as a representative example of a wireless wide area network.

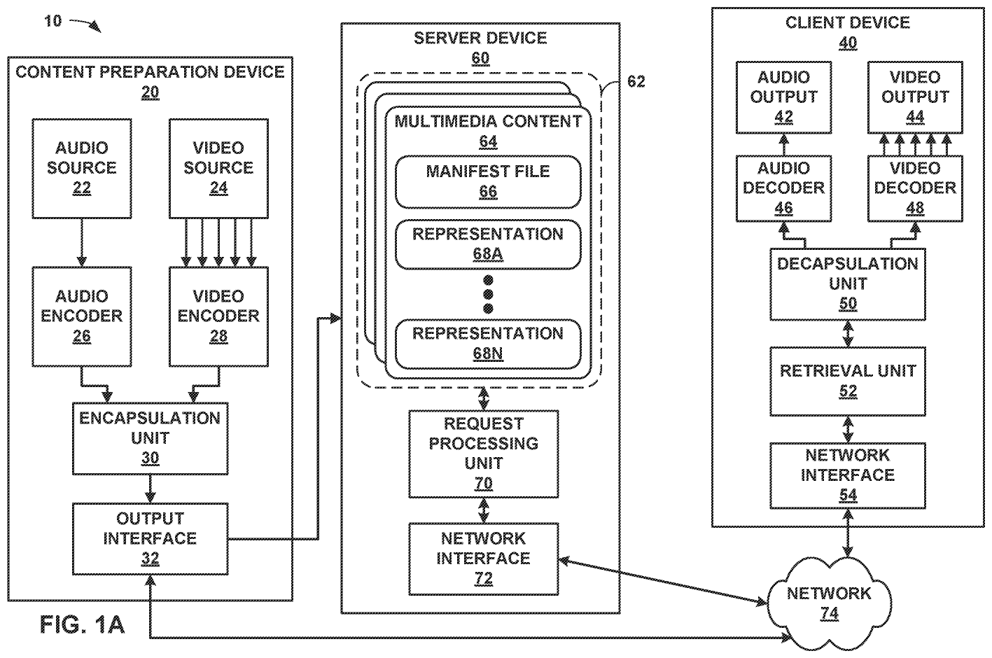

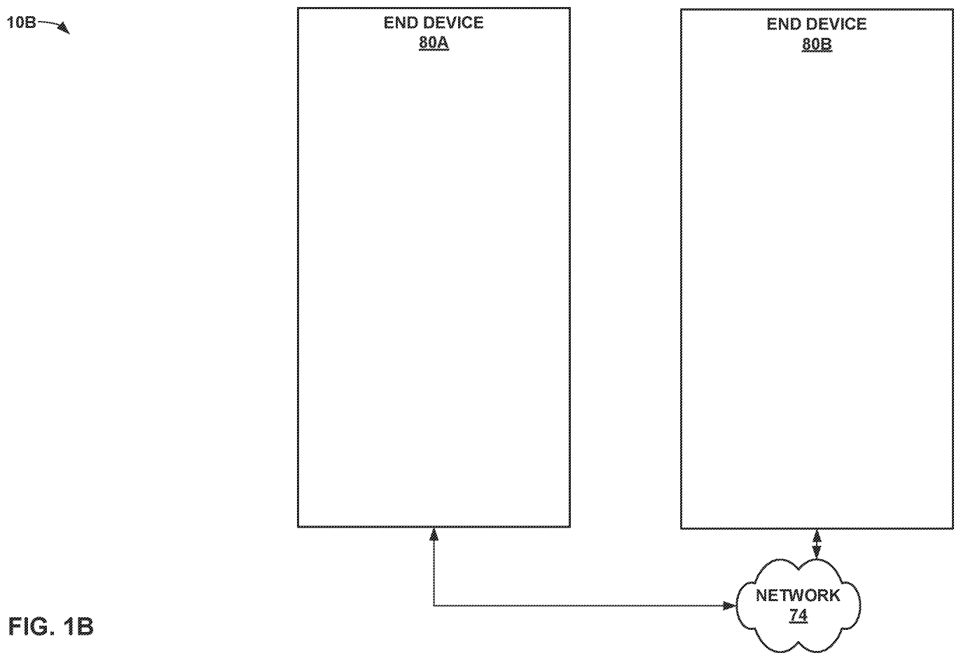

FIG. 1A is a block diagram illustrating an example system 10 that implements techniques for streaming media data over a network. In this example, system 10 includes content preparation device 20, server device 60, and client device 40. Server device 60 may be an XR application server. Client device 40 and server device 60 are communicatively coupled by network 74, which may comprise a wireless wide area network, a wireless local area network, the Internet, and/or the like. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1A, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp. Note that these timestamps may be different than timestamps discussed herein with respect to use for determining a data packet delay, such as an end-to-end delay, which may be contained in a packet, such as in a header extension element or a packet payload.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1A, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1A. server device 60 includes storage medium 62 that stores various multimedia contents 64. each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. In some examples, request processing unit 70 may receive network requests from client device 40 in the form of RTP/SRTP packets and may deliver content, such as XR application content, to client device 40 in the form of RTP/SRTP packets. In some examples, the RTP/SRTP packets may include one or more time indicators, such as timestamps or delay measurement messages, which may used to determine a delay, such as a delay caused by the RTP/SRTP packets traversing one or more networks.

Additionally, or alternatively, request processing unit 70 may implement hypertext transfer protocol (HTTP) version 1.1, as described in RFC 2616, “Hypertext Transfer Protocol-HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally, or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1A, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The example of FIG. 1A describes the use of RTP, DASH, and HTTP-based streaming for purposes of example. However, it should be understood that other types of protocols may be used to transport media data. For example, request processing unit 70 and retrieval unit 52 may be configured to operate according to Real-time Streaming Protocol (RTSP), or the like, and use supporting protocols such as Session Description Protocol (SDP) or Session Initiation Protocol (SIP).

FIG. 1B is a block diagram illustrating another example system that implements techniques for streaming media data over a network. FIG. 1B is similar to the example of FIG. 1A, but FIG. 1B includes two end devices, rather than a client device and a server device. For example, each end device 80A and 80B of system 10B may be configured to both consume content from and provide content to the other of client device 80A and 80B. The system of FIG. 1B may implement the techniques disclosed herein.

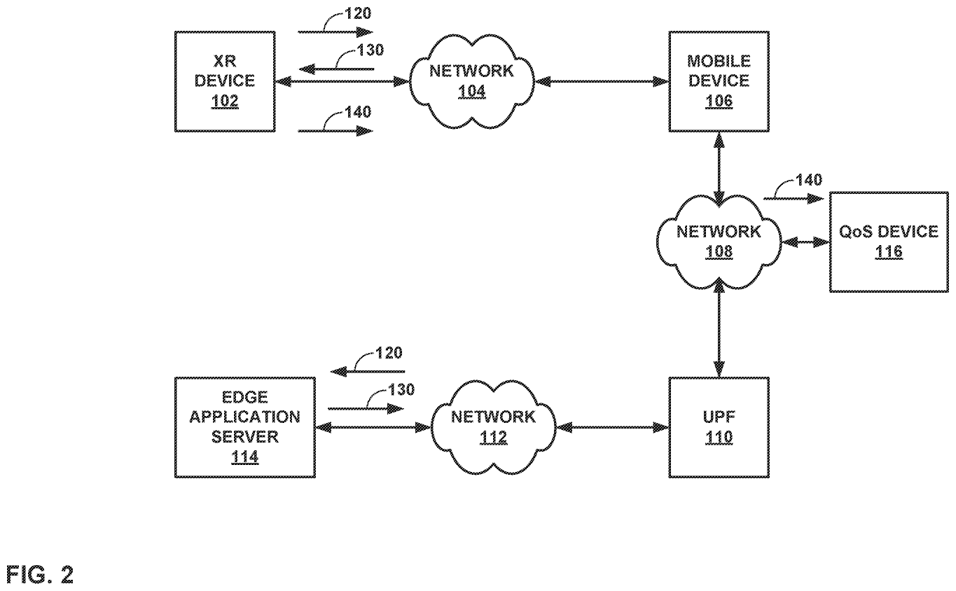

FIG. 2 is a block diagram illustrating an end-to-end XR system in which data packets traverse more than one network.

XR device 102, which may be an example of client device 40 or a portion thereof, may be coupled to network 104. In some examples, XR device 102 may include XR glasses or an XR headset configured to deliver XR content to a user. In some examples, network 104 may include a wireless local area network, such as a Wi-Fi network. In some examples, network 104 may include multiple networks, such as a Wi-Fi network cascaded with an Ethernet.

Mobile device 106, which may be an example of client device 40 or a portion thereof, may be coupled to network 104 and network 108. Network 108 may include a wireless wide area network, such as a 5G network.

User plane function (UPF) 110 may be coupled to network 108 and network 112. Network 112 may include the Internet. In some examples, Network 112 may also include one or more local networks. Edge application server 114, which may be an example of server device 60, may be coupled to network 112 and to content preparation device 20 (not shown in FIG. 2). As such, an end-to-end connection between XR device 102 and edge application server 114 may traverse a plurality of networks, network 104, network 108, and network 112. These networks may be networks of different types, having different delay properties and different mechanisms for determining delay, for example, for quality of service (QOS) purposes. As such, techniques for determining an end-to-end delay may be desirable.

Network 108 may be coupled with QoS device 116. QoS device may be any computing device that may compute delays or compare delays to delay thresholds for QoS purposes.

According to the techniques of this disclosure, XR device 102 may transmit to edge application server 114 (and/or any intervening computing device), a first data packet 120, first data packet 120 including a first time indicator and at least one header extension element, the at least one header extension element including a header extension element header, the header extension element header having a length of at least one byte. XR device 102 may receive from edge application server 114 (and/or any intervening computing device), a second data packet 130, second data packet 130 including a second time indicator. XR device 102 may determine a data packet delay associated with first data packet 120 based on the first time indicator and the second time indicator and transmit an indication of the data packet delay to edge application service 114 (and/or any intervening computing device) and/or QoS device 116. For example, indication of the data packet delay 140 may include information relating to a delay associated with network 104 and network 112 (such as a length of time of the delay) or a delay associated with each of network 104, network 108, and network 112 (such as a length of time of the delay). QoS device 116 may utilize indication of the data packet delay 140 to adjust parameters within network 108 to attempt to ensure that an end-to-end path (such as a one-way delay or a round-trip delay) between XR device 102 and edge application server 114 meets any QoS requirements associated with an application of edge application service 114 being utilized by XR device 102.

For example, it may be desirable for QoS device 116 to target an end-to-end delay. One way to provision a target end-to-end delay Dₑ₂ₑ is for QoS device 116 of the 5G network (e.g., network 108) to set the delay in the 5G network D_{c} according to the non-5G network delays Dₙ, i.e., D_{c}=Dₑ₂ₑ−Dₙ, where Dₙ includes a delay between XR device 102 to mobile device 106 (e.g., a delay associated with network 104) and a delay between edge application server 114 and UPF 110 (e.g., a delay associated with network 112).

According to the techniques of this disclosure, edge application server 114 may receive, from XR device 102 (and/or any intervening computing device) first data packet 120, first data packet 120 including a first time indicator. Edge application server 114 may transmit, to XR device 102 (and/or any intervening computing device), second data packet 130, second data packet 130 may include a second time indicator, a third time indicator, and at least one header extension element, the at least one header extension element comprising a header extension element header, the header extension element header having a length of at least one byte (e.g., one byte or two bytes). In some examples, XR device 102 may utilize the second time indicator, the third time indicator, and/or a fourth time indicator which may be generated by XR device 102 upon receipt of second data packet 130 when determining the data packet delay. Indication of data packet delay 140 may include an indication of delay attributed to network 104 and network 112 in one direction (delay of first data packet 120) or an indication of delay attributed to network 104 and network 112 in both directions (e.g., a round-trip delay: the delay of first data packet 120 and delay of second data packet 130 with or without a processing delay caused by edge application server 114 processing first data packet 120). Such an indication of delay may or may not include an indication of delay attributed to network 108. In some examples, the round-trip delay may include a processing delay of edge application server 114 in processing first data packet 120.

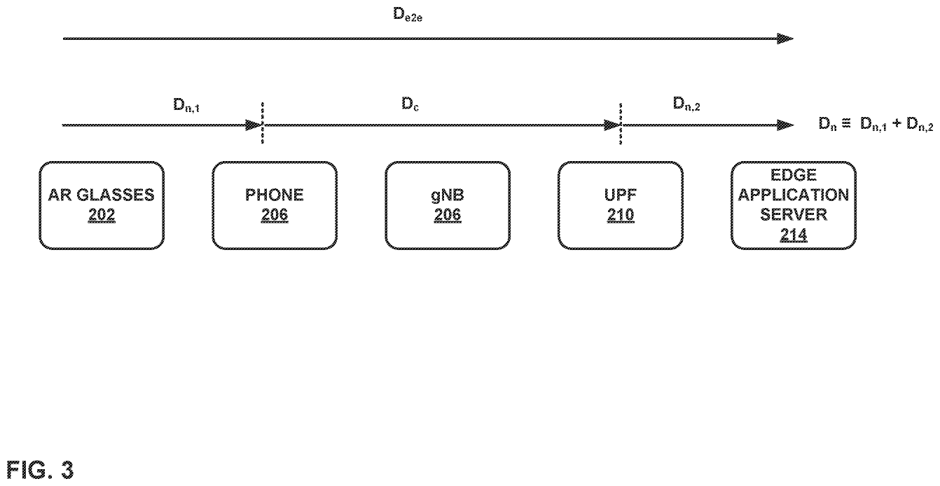

FIG. 3 is a conceptual diagram illustrating example delays in an end-to-end connection for an XR application according to one or more aspects of this disclosure. In the example of FIG. 3, the wireless wide area network (such as network 108) is referred to as a 5G network, represented as gNodeB (gNB) 206 in FIG. 3. As can be seen in FIG. 3, the end-to-end delay Dₑ₂ₑ may be equal to the in the 5G network D_{c} between phone 206 (which may be an example of mobile device 106) and UPF 210 (which may be an example of UPF 110), plus the delay from the AR glasses 202 (which is an example of XR device 102) to phone 206, D_{n,1} and the delay from UPF 210 to edge application server 214, D_{n,2}. The delay, other than delay in the 5G network D_{c}, may therefore be the delays D_{n,1}+D_{n,2}.

The non-5G network delays may be estimated via end-to-end delay measurements. There are existing schemes or techniques to measure 5G network delay D_{c}, e.g., per TS23.501 clause 5.33.3. Measurement packets (on the 5G network and non-5G networks) should be representative of XR data packets: e.g., have a same QoS treatment, similar packet size, etc.

However, the QoS treatment received by measurement packets may be different from that received by the data packets themselves, e.g., using out-of-band measurement techniques. For example, in the 5G network, a measurement message and a data packet may use different protocols (e.g., ICMP messages (Echo or Echo Reply). For example, the measurement message may have protocol number 1, while data packets (RTP/UDP) may have protocol number 17. A measurement message and a data packet may have different IP 5-tuples (IP source address, IP destination address, source port number, destination port number, protocol number). A measurement message and a data packet may be mapped to different QoS flows, and may receive different QoS treatment in the 5G network. On the Internet, the measurement packet and the data packet may differ in the DSCP value in the IP packet header. In a Wi-Fi network (e.g., network 104), the measurement packet and the data packet may be mapped to different access categories. Additionally, the packet size difference between the measurement packet and the data packet may affect the accuracy of the delay measurement, especially for low bit rate links.

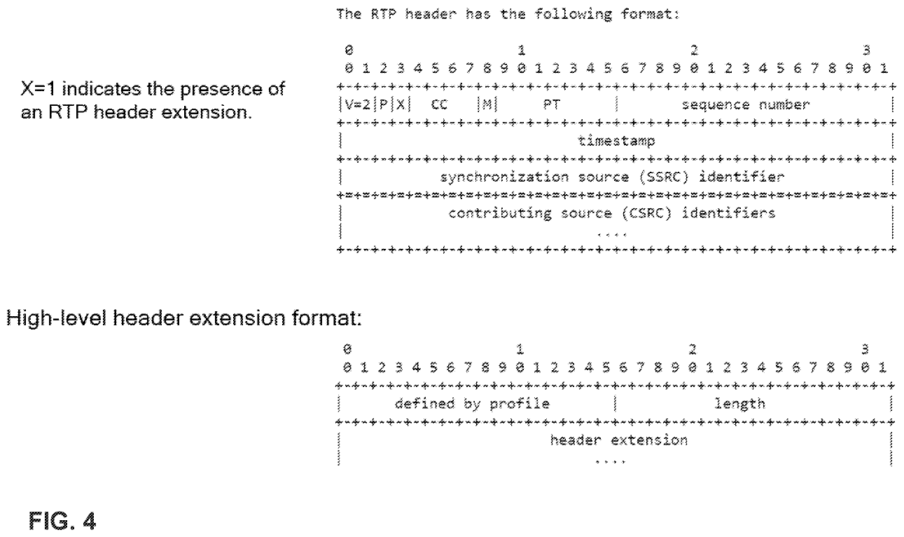

As such it may be desirable to include header extension elements for improving the accuracy of delay measurements. FIG. 4 is a conceptual diagram illustrating an example RTP/SRTP packet and RTP header extension format (RFC 3550).

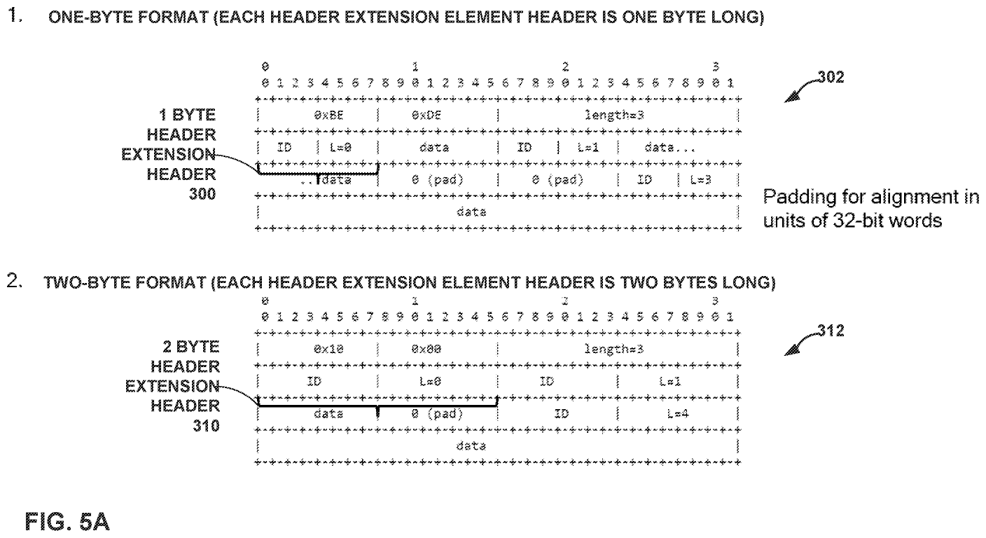

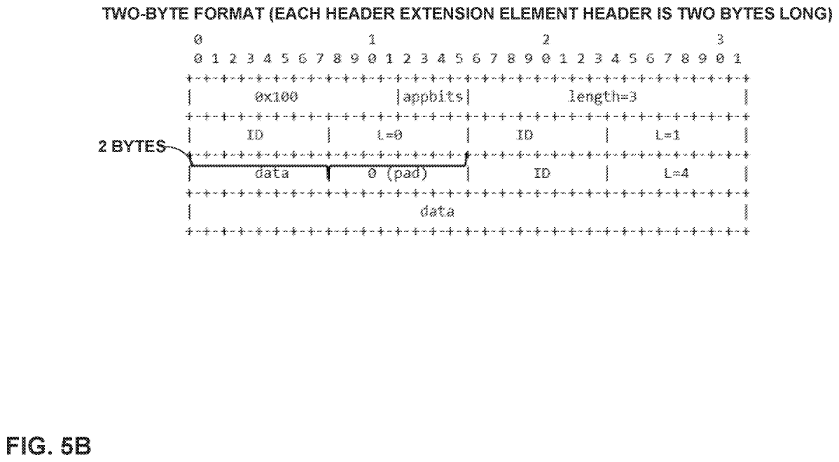

FIGS. 5A-5B are conceptual diagrams illustrating example RTP packet formats (RFC 8285). RTP header extension formats for in-band delay measurements are now described. Piggybacked content may include delay measurement messages or timestamps or any other information related to delay measurements. In some examples, timestamps or delay measurement messages may be located either in a header extension or in the data packet payload. An header extension may include one or multiple header extension elements, such as header extension element 302 or header extension element 312. The header (the identifier (ID) field and the L field) of an extension element header (referred to herein as a header extension element header) may be one-byte in length, as shown in header extension element header 300, or two-bytes in length, as shown in header extension element header 310. There are disclosed herein a plurality of types of header extension formats. The example of FIG. 5B includes “appbits” which, in some examples, may be a 4-bit field that is application dependent and may be defined based on the application or to be any value (e.g., all zeros, or some other value). Header extension element 302 and/or header extension element 312 are examples of header extension elements that may be included in first data packet 120 and/or second data packet 130 (FIG. 2).

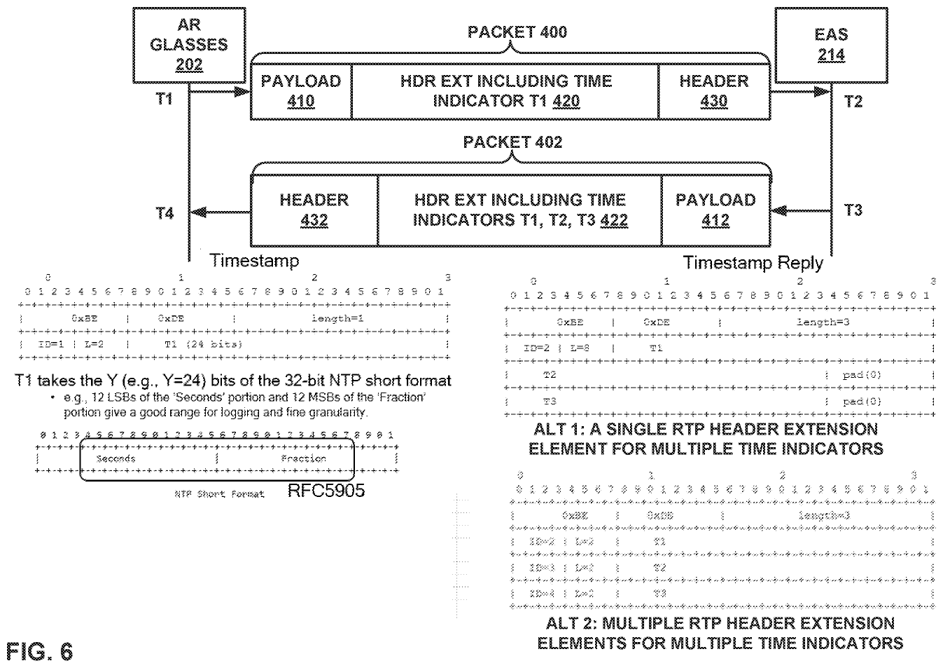

FIG. 6 is a conceptual diagram illustrating an example one-byte format with timestamps in a header extension according to one or more aspects of this disclosure. Packet 400 may be an example of first data packet 120. Packet 400 may include: a payload 410, which, for example, may include video data; a header extension 420, which may include one or more header extension elements, such as header extension element 302, carrying a first time indicator T1; and a header 430, which may be an RTP header.

Packet 402 may be an example of second data packet 130. Packet 402 may include: a payload 412, which in this example may include video data; a header extension 422, which may include one or more header extension elements, such as header extension element 302, carrying first time indicator T1, a second time indicator T2, and a third time indicator T3 and/or be an example of header extension element 302; and a header 432, which may be an RTP header. Edge application server 214 may determine second time indicator T2 upon receiving packet 400 and may determine third time indicator T3 after processing packet 400 and before transmitting packet 402. In some examples, a difference between second time indicator T2 and third time indicator T3 may represent a processing delay associated with edge application server 214 processing packet 400.

AR glasses 202 may determine a fourth time indicator T4 upon receiving packet 402. AR glasses 202 may use first time indicator T1, second time indicator T2, third time indicator T3, and/or time indicator T4 when determining a data packet delay.

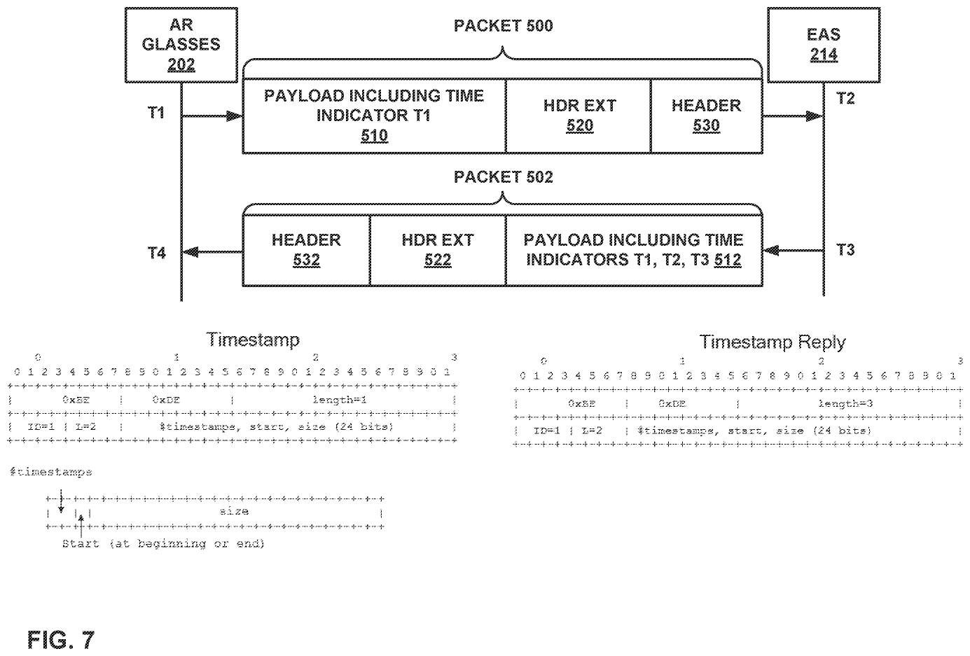

FIG. 7 is a conceptual diagram illustrating an example one-byte format with timestamps in a payload according to one or more aspects of this disclosure. Packet 500 may be an example of first data packet 120. Packet 500 may include: a payload 510, which may include first time indicator T1 and, for example, video data; a header extension 520, which may include one or more header extension elements, such as header extension element 302, carrying information relating to first time indicator T1; and a header 530, which may be an RTP header.

Packet 502 may be an example of second data packet 130. Packet 502 may include: a payload 412, which in this example may include first time indicator T1, a second time indicator T2, a third time indicator T3, and video data; a header extension 522, which may include one or more header extension elements, such as header extension element 302, carrying information relating to first time indicator T1, second time indicator T2, and third time indicator T3 and/or be an example of header extension element 302; and a header 432, which may be an RTP header. Edge application server 214 may determine second time indicator T2 upon receiving packet 500 and may determine third time indicator T3 after processing packet 500 and before transmitting packet 502. In some examples, a difference between second time indicator T2 and third time indicator T3 may represent a processing delay associated with edge application server 214 processing packet 500.

AR glasses 202 may determine a fourth time indicator T4 upon receiving packet 502. AR glasses 202 may use first time indicator T1, second time indicator T2, third time indicator T3, and/or time indicator T4 when determining a data packet delay.

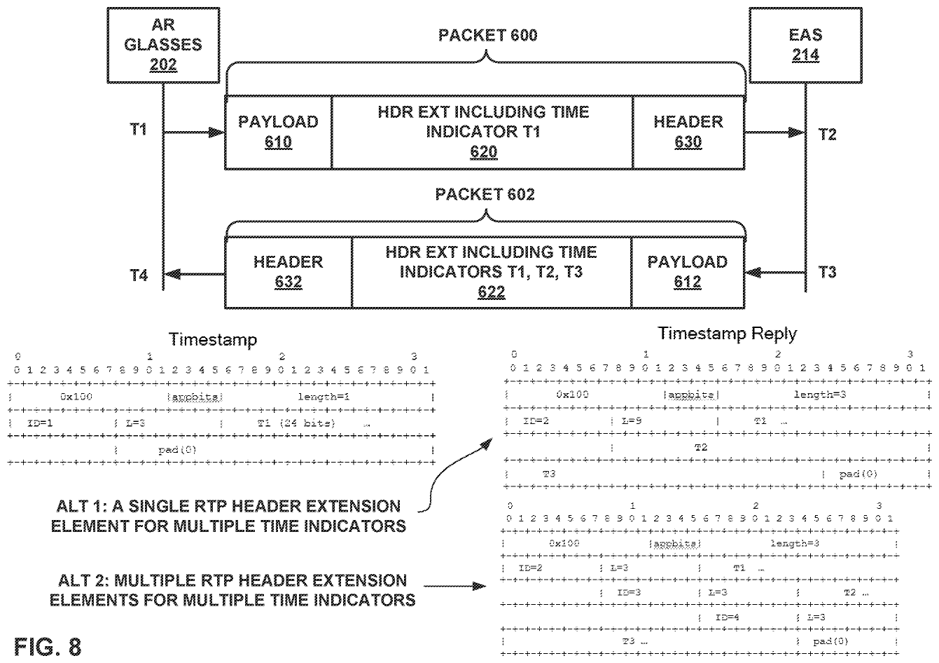

FIG. 8 is a conceptual diagram illustrating an example two-byte format with timestamps in a header extension according to one or more aspects of this disclosure. In the example of FIG. 8, appbits may be set to all zeros, or used to indicate information about the header extension elements, for example, the format of the time indicator(s) carried in the RTP header extension elements. Packet 600 may be an example of first data packet 120. Packet 600 may include: a payload 610, which in this example may include video data; a header extension 620, which may include one or more RTP header extension elements, such as header extension element 312, carrying a first time indicator T1; and a header 630, which may be an RTP header.

Packet 602 may be an example of second data packet 130. Packet 602 may include: a payload 612, which in this example may include video data; a header extension 622, which may include one or more header extension elements, such as header extension element 312, carrying first time indicator T1, a second time indicator T2, and a third time indicator T3; and a header 632, which may be an RTP header. Edge application server 214 may determine second time indicator T2 upon receiving packet 600 and may determine third time indicator T3 after processing packet 600 and before transmitting packet 602. In some examples, a difference between second time indicator T2 and third time indicator T3 may represent a processing delay associated with edge application server 214 processing packet 600.

AR glasses 202 may determine a fourth time indicator T4 upon receiving packet 602. AR glasses 202 may use first time indicator T1, second time indicator T2, third time indicator T3, and/or time indicator T4 when determining a data packet delay.

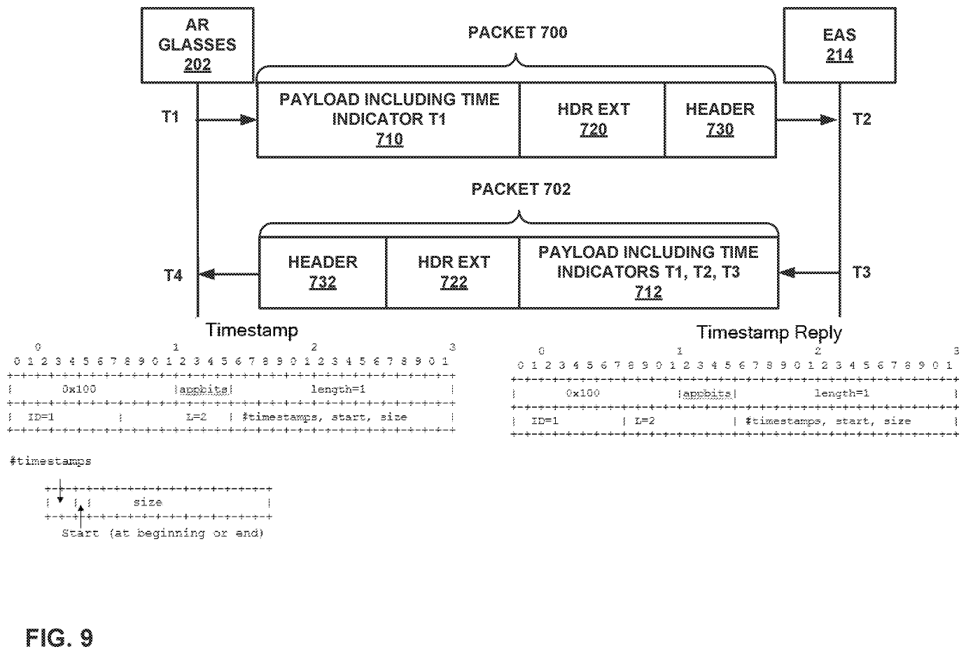

FIG. 9 is a conceptual diagram illustrating an example two-byte format with timestamps in a payload according to one or more aspects of this disclosure. Packet 700 may be an example of first data packet 120. Packet 700 may include: a payload 710, which in this example may include a first time indicator T1 and video data; a header extension 720, which may include one or more header extension elements, such as header extension element 312, carrying information relating to first time indicator T1; and a header 730, which may be an RTP header.

Packet 702 may be an example of second data packet 130. Packet 702 may include: a payload 712, which may include first time indicator T1, a second time indicator T2, a third time indicator T3, and video data; a header extension 722, which may include one or more header extension elements, such as header extension element 312, carrying information relating to first time indicator T1, second time indicator T2, and third time indicator T3; and a header 732, which may be an RTP header. Edge application server 214 may determine second time indicator T2 upon receiving packet 700 and may determine third time indicator T3 after processing packet 700 and before transmitting packet 702. In some examples, a difference between second time indicator T2 and third time indicator T3 may represent a processing delay associated with edge application server 214 processing packet 700.

AR glasses 202 may determine a fourth time indicator T4 upon receiving packet 702. AR glasses 202 may use first time indicator T1, second time indicator T2, third time indicator T3, and/or time indicator T4 when determining a data packet delay.

In each of the examples of FIGS. 6-9, the first time indicator, the second time indicator, the third time indicator, and the fourth time indicator may be timestamps or delay measurement messages.

For example, the techniques of this disclosure may utilize piggybacking timestamps. The end points (e.g., the end point devices, such as XR device 102 and edge application server 114) may negotiate the format for the RTP header extension for delay measurement. In a first example, an identifier (ID) field in a header extension element header indicates timestamps are piggybacked in a header extension element (e.g., header extension element 420, 422, 620, or 622), and specifically may include the number of timestamps and/or the format of the timestamps, as different timestamps may have different formats. For example, ID=1 may indicate one timestamp, which may be the middle 24 bits of an NTP timestamp in the 32-bit format, whereas ID=2 may indicate three timestamps, which may be the middle 24 bits of an NTP timestamp in the 32-bit format. In some examples, when the RTP header extension includes multiple timestamps, multiple RTP header extension elements may be used, for example, one timestamp is carried in the data part of a separate RTP header extension element, as shown as ALT 2 in FIG. 6 for the one-byte format or as shown as ALT 2 in FIG. 8 for the two-byte format. The case of a single RTP header extension element including multiple timestamps is shown as ALT 1 for the one-byte format in FIG. 6 or as shown as ALT 2 for the two-byte format in FIG. 8.

In a second example, the ID field in a header extension element header indicates timestamp(s) being piggybacked in the packet payload (e.g., payload 510, 512, 710, or 712). Further, the ID or the data field of the header extension element header may indicate the number of timestamp(s), the location of the timestamp(s), and/or the format and length of the timestamp(s).

In some examples, the header extension element header may be in the one-byte format (ID field+L field totals one byte) or the two-byte format (ID field+L field totals two bytes). In some examples, the techniques of this disclosure may include piggybacking delay measurement messages.

The end points (e.g., the end point devices, such as XR device 102 and edge application server 114) may negotiate the format for the RTP header extension element for delay measurement. In a first example, the ID field in a header extension element header indicates delay measurement message(s) being piggybacked in a header extension element (e.g., header extension element 420, 422, 620, or 622), and specifically may include the number of delay measurement messages and/or the types of the delay measurement message (e.g., ICMP Echo, Echo Reply, Timestamp, Timestamp Reply per RFC792); PTP messages-Pdelay_Req, Pdelay_Resp, and/or Pdelay_Resp_Follow_Up per IEEE-1588-2019). For example, ID=1 may mean ICMP Timestamp message, whereas ID=2 may mean ICMP Timestamp Reply message.

In a second example, the ID field in a header extension element indicates delay measurement messages being piggybacked in a packet payload (e.g., payload 510, 512, 710, or 712). Further, the ID or the data field of the header extension element may indicate the number of delay measurement messages, the location of the delay measurement messages, and/or the types of the delay measurement messages.

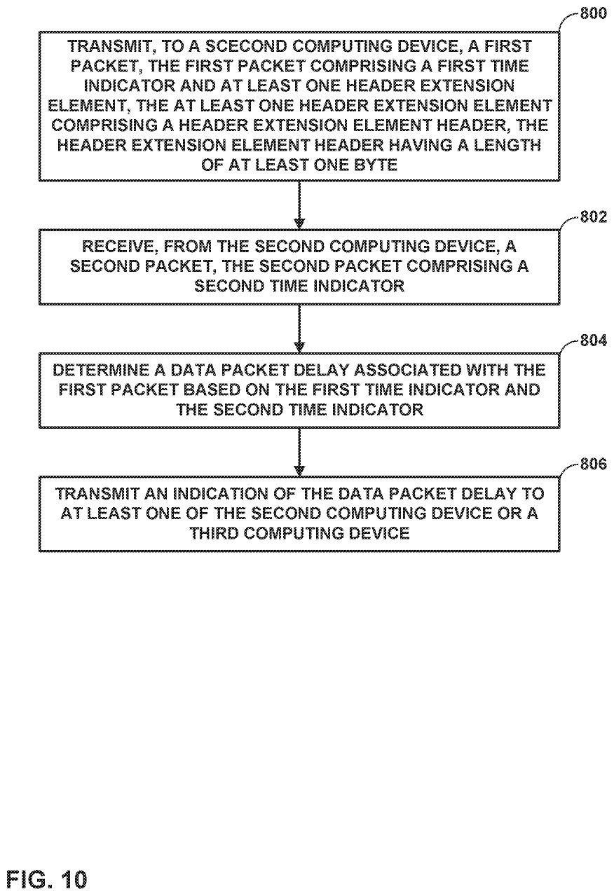

FIG. 10 is a flow diagram illustrating an example data packet delay technique according to one or more aspects of this disclosure. While the example of FIG. 10 is described with respect to the computing devices of FIG. 2, the techniques of FIG. 10 may be practiced by any computing device capable of performing such techniques. A first computing device (e.g., XR device 102 and/or mobile device 106) may transmit, to a second computing device (e.g., mobile device 106, UPF 110 and/or edge application server 114), a first data packet 120, first data packet 120 including a first time indicator T1 and at least one header extension element (e.g., header extension element 420, 520, 620, or 720), the at least one header extension element comprising a header extension element header (e.g., header extension element header 300 or 310), the header extension element header having a length of at least one byte (800).

The first computing device (XR device 102 and/or mobile device 106) may receive, from the second computing device (e.g., mobile device 106, UPF 110 and/or edge application server 114), second data packet 130, second data packet 130 comprising a second time indicator T2 (802).

The first computing device (XR device 102 and/or mobile device 106) may determine a data packet delay associated with first data packet 120 based on first time indicator T1 and second time indicator T2 (804). For example, the data packet delay may include a length of time of a delay associated with network 104 and network 112, D_{n,1}+D_{n,2}, or a length of time of delay associated with each of network 104, network 108, and network 112, Dₑ₂ₑ.

The first computing device (XR device 102 and/or mobile device 106) may transmit an indication of the data packet delay 140 to at least one of the second computing device (e.g., mobile device 106, UPF 110 and/or edge application server 114) or a third computing device (e.g., QoS device 116) (806).

In some examples, the at least one header extension element (e.g., header extension element 420, 520, 620, or 720) includes first time indicator T1. In some examples, the at least one header extension element includes an indication that a payload of first data packet 120 (e.g., payload 410, 510, 610, or 710) includes first time indicator T1, wherein first data packet 120 further includes the payload, and wherein the payload includes first time indicator T1.

In some examples, the header extension element header (e.g., header extension element header 300 or 310) includes an identifier and a length indicator, the length indicator being indicative of the length of the header extension element. In some examples, the identifier includes information indicative of at least one of a) a number of time indicators contained in the header extension element of first data packet 120, or b) first time indicator T1 being in a payload of first data packet 120. In some examples, the header extension element further includes a start first time indicator T1, a location of first time indicator T1, a length of first time indicator T1, or a type of first time indicator T1.

In some examples, first data packet 120 is an RTP packet or an SRTP packet. In some examples, first time indicator T1 includes a timestamp or a delay measurement message.

In some examples, as part of determining the data packet delay associated with first data packet 120, the first computing device is configured to determine a one-way (e.g., uplink) transit time of first data packet 120 based on first time indicator T1 and second time indicator T2. For examples, the first computing device may determine the data packet delay may to be length of time of a delay associated with network 104 and network 112, D_{n,1}+D_{n,2}, or a length of time of delay associated with each of network 104, network 108, and network 112, Dₑ₂ₑ. In the event the length of time delay is the data packet delay associated with each of network 104, network 108, and network 112, Dₑ₂ₑ, QOS device 116 may determine D_{n,1}+D_{n,2} by subtracting D_{c} (which may be determinable by QoS device 116 or gNB 206) from Dₑ₂ₑ. QOS device 116 may then adjust parameters of network 108 in an attempt to ensure a level of QoS (such as a maximum one-way or round-trip packet delay) for an application of edge application server 114.

In some examples, the first computing device may be further configured to determine a fourth time indicator T4 based on receiving second data packet 130, wherein as part of determining the data packet delay associated with first data packet 120, the first computing device is configured to determine a reverse one-way (e.g., downlink) transit time of second data packet 130 based on third time indicator T3 in second data packet 130 and fourth time indicator T4. In such examples, the first computing device is configured to determine the data packet delay by adding the one-way (e.g., uplink) transit time and the reverse one-way (e.g., downlink) transit time. In some examples, as part of determining the data packet delay, the first computing device is further configured to determine a processing delay based on second time indicator T2 and third time indicator T3, and determine the data packet delay by further adding the processing delay to the one-way transit time and the reverse one-way transit time.

In some examples, a communication path between the first computing device and the second computing device spans a first communication network that is a 5G network and at least one second communication network that is not a 5G network.

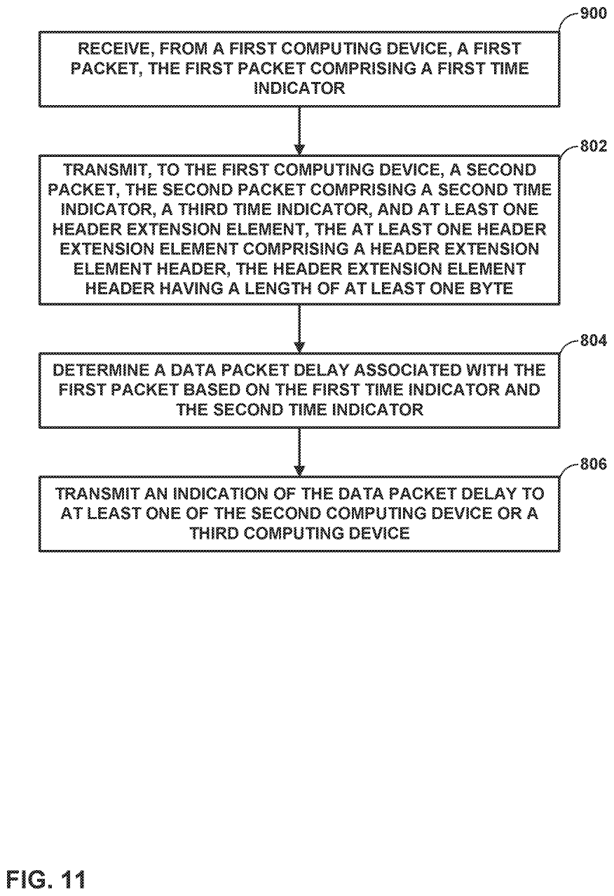

FIG. 11 is a flow diagram illustrating another example data packet delay technique according to one or more aspects of this disclosure. While the example of FIG. 11 is described with respect to the computing devices of FIG. 2, the techniques of FIG. 11 may be practiced by any computing device capable of performing such techniques. A second computing device (e.g., mobile device 106, UPF 110 and/or edge application server 114) may receive, from a first computing device (XR device 102 and/or mobile device 106), first data packet 120, first data packet 120 including a first time indicator T1 (900).

The second computing device (e.g., mobile device 106, UPF 110 and/or edge application server 114) may transmit, to the first computing device (XR device 102 and/or mobile device 106), second data packet 130, second data packet 130 comprising a second time indicator T2, a third time indicator T3, and at least one header extension element (e.g., header extension element 422, 522, 622, or 722), the at least one header extension element comprising a header extension element header (e.g., header extension element header 300 or 310), the header extension element header having a length of at least one byte (900).

In some examples, first time indicator T1 includes a first timestamp or first delay measurement. In some examples, second time indicator T2 includes a second timestamp or a second delay measurement message and is associated with a receive time of first data packet 120. For example, second time indicator T2 may be indicative of a time first data packet 120 is received by edge application server 114. In some examples, third time indicator T3 includes a third timestamp or a third delay message and is associated with a processing time of first data packet 120. For example, third time indicator T3 may be indicative of a time it took edge application server 114 to process first data packet 120. In some examples, edge application server 114 may add third time indicator T3 to second data packet 130 immediately prior to edge application server 114 transmitting second data packet 130.

In some examples, the at least one header extension element (e.g., header extension element 422, 522, 622, or 722) includes second time indicator T2 and third time indicator T3. In some examples, the at least one header extension element comprises an indication that a payload of second data packet 130 (e.g., payload 412, 512, 612, or 712) includes second time indicator T2 and third time indicator T3. In some examples, second data packet 130 further includes the payload, and the payload includes second time indicator T2 and third time indicator T3.

In some examples, the header extension element header (e.g., header extension element header 300 or 310) includes an identifier and a length indicator, the length indicator being indicative of the length of the header extension element. In some examples, the identifier includes information indicative of at least one of a) a number of time indicators contained in the header extension element or second data packet 130, or b) second time indicator T2 and third time indicator T3 being in a payload of second data packet 130. In some examples, the header extension element further includes a start of second time indicator T2, a location of second time indicator T2, a length of second time indicator T2, or a type of second time indicator T2 (e.g., a timestamp, or a type of delay measurement message). It should be understood that the header extension element of second data packet 130 may include similar information with respect to first time indicator T1, third time indicator T3 and/or fourth time indicator T4.

In some examples, the second computing device includes a server (e.g., edge application server 114).

Various examples of the techniques of this disclosure are summarized in the following clauses:
Clause 1A: A method of processing media data, the method comprising: indicating, in an RTP header extension, information relating to a time indicator; placing, at a first device, the time indicator in a portion of an RTP/SRTP packet; and forwarding the RTP/SRTP packet to a second device.
Clause 2A. A method of processing media data, the method comprising: receiving, by a second device and from a first device, an RTP/SRTP packet comprising an RTP header extension and a time indicator in a portion of the packet; determining, by the second device, information related to the time indicator based on the RTP header extension; and determining, by the second device, a delay based on the time indicator.

Clause 3A. The method of clause 1A or clause 2A, wherein the information relating to the time indicator comprises at least one of an indication of a number of time indicators, a start of the time indicators, and a length of at least one of the time indicators in the RTP/SRTP packet.
Clause 4A. The method of any of clauses 1A-3A, wherein the RTP header extension comprises one or more RTP header extension elements and wherein the header of an RTP header extension element comprises one byte.
Clause 5A. The method of any of clauses 1A-3A, wherein the RTP header extension comprises one or more RTP header extension elements and wherein the header of an RTP header extension element comprises two bytes.
Clause 6A. The method of any of clauses 1A-5A, wherein the portion of the RTP/SRTP packet comprises the RTP header extension.
Clause 7A. The method of any of clauses 1A-5A, wherein the portion of the RTP/SRTP packet comprises a payload.
Clause 8A. The method of any of clauses 1A-7A, wherein the time indicator comprises a timestamp.
Clause 9A. The method of any of clauses 1A-7A, wherein the time indicator comprises a delay measurement message.
Clause 10A. The method of any of clauses 1A-9A, wherein at least one of the first device or the second device comprises at least one of an augmented reality device, an extended reality device, a virtual reality device, mobile device, a UPF, or an edge application server.
Clause 11A. A device for processing an RTP/SRTP packet comprising: a memory configured to store the RTP/SRTP packet; and one or more processors implemented in circuitry and communicatively coupled to the memory, the one or more processors being configured to perform the method of any of clauses 1A-10A.
Clause 12A. A computer-readable storage medium having stored thereon instructions that, when executed, cause a processor to perform the method of any of clauses 1A-10A.
Clause 13A. A device for processing an RTP/SRTP packet, the device comprising at least one means for performing the method of any of clauses 1A-10A.
Clause 1B. A method comprising: transmitting, by a first computing device to a second computing device, a first data packet, the first data packet comprising a first time indicator and at least one header extension element, the at least one header extension element comprising a header extension element header, the header extension element header having a length of at least one byte; receiving, by the first computing device from the second computing device, a second data packet, the second data packet comprising a second time indicator; determining, by the first computing device, a data packet delay associated with the first data packet based on the first time indicator and the second time indicator; and transmitting, by the first computing device, an indication of the data packet delay to at least one of the second computing device or a third computing device.
Clause 2B. The method of clause 1B, wherein at least one header extension element comprises the first time indicator.
Clause 3B. The method of clause 1B, wherein the at least one header extension element comprises an indication that a payload of the first data packet includes the first time indicator, wherein the first data packet further comprises the payload, and wherein the payload comprises the first time indicator.
Clause 4B. The method of any of clauses 1B-3B, wherein the header extension element header comprises an identifier and a length indicator, the length indicator being indicative of the length of the header extension element.
Clause 5B. The method of clause 4B, wherein the identifier comprises information indicative of at least one of a) a number of time indicators contained in the header extension element or the first data packet, or b) the first time indicator being in a payload of the first data packet.
Clause 6B. The method of clause 4B, wherein the header extension element further comprises a start the first time indicator, a location of the first time indicator, a length of the first time indicator, or a type of the first time indicator.
Clause 7B. The method of any of clauses 1B-6B, wherein the first data packet is an RTP packet or an SRTP packet.
Clause 8B. The method of any of clauses 1B-7B, wherein the first time indicator comprises a timestamp or a delay measurement message.
Clause 9B. The method of any of clauses 1B-8B, wherein determining the data packet delay associated with the first data packet comprises determining a one-way transit time of the first data packet based on the first time indicator and the second time indicator.
Clause 10B. The method of clause 9B, further comprising determining a fourth time indicator based on receiving the second data packet, wherein determining the data packet delay associated with the first data packet comprises: determining a reverse one-way transit time of the second data packet based on a third time indicator in the second data packet and the fourth time indicator; and determining the data packet delay by adding the one-way transit time, the reverse one-way transit time.
Clause 11B. The method of clause 10B, wherein determining the data packet delay further comprises: determining a processing delay based on the second time indicator and the third time indicator; and determining the data packet delay by further adding the processing delay to the one-way transit time and the reverse one-way transit time.
Clause 12B. The method of any of clauses 1B-11B, wherein a communication path between the first computing device and the second computing device spans a first communication network that is a 5G network and at least one second communication network that is not a 5G network.
Clause 13B. A first computing device, comprising: memory configured to store a first data packet; and one or more processors coupled to the memory, the one or more processors being configured to: transmit to a second computing device the first data packet, the first data packet comprising a first time indicator and at least one header extension element, the at least one header extension element comprising a header extension element header, the header extension element header having a length of at least one byte; receive from the second computing device a second data packet, the second data packet comprising a second time indicator; determine a data packet delay associated with the first data packet based at least in part on at least one of the first time indicator or the second time indicator; and transmit an indication of the data packet delay to at least one of the second computing device or a third computing device.
Clause 14B. The first computing device of clause 13B, wherein at least one header extension element comprises the first time indicator.
Clause 15B. The first computing device of clause 13B, wherein the at least one header extension element comprises an indication that a payload of the first data packet includes the first time indicator, wherein the first data packet further comprises the payload, and wherein the payload comprises the first time indicator.
Clause 16B. The first computing device of clause 13B, wherein the header extension element header comprises an identifier and a length indicator, the length indicator being indicative of the length of the header extension element.
Clause 17B. The first computing device of clause 16B, wherein the identifier comprises information indicative of at least one of a) a number of time indicators contained in the header extension element or the first data packet, or b) the first time indicator being in a payload of the first data packet.
Clause 18B. The first computing device of clause 16B, wherein the header extension element further comprises a start the first time indicator, a location of the first time indicator, a length of the first time indicator, or a type of the first time indicator.
Clause 19B. The first computing device of any of clauses 13B-18B, wherein the first data packet is an RTP packet or an SRTP packet.
Clause 20B. The first computing device of any of clauses 13B-19B, wherein the first time indicator comprises a timestamp or a delay measurement message.
Clause 21B. The first computing device of any of clauses 13B-20B, wherein as part of determining the data packet delay associated with the first data packet, the one or more processors are configured to determine a one-way transit time of the first data packet based on the first time indicator and the second time indicator.
Clause 22B. The first computing device of clause 21B, wherein the one or more processors are further configured to determine a fourth time indicator based on receiving the second data packet, wherein as part of determining the data packet delay associated with the first data packet, the one or more processors are further configured to: determine a one-way transit time of the second data packet based on a third time indicator in the second data packet and the fourth time indicator; and determine a roundtrip data packet delay by adding the one-way transit time and the reverse one-way transit time.
Clause 23B. The first computing device of clause 22B, wherein as part of determining the data packet delay, the one or more processors are further configured to: determine a processing delay based on the second time indicator and the third time indicator; and determine the data packet delay by further adding the processing delay to the one-way transit time and the reverse one-way transit time.
Clause 24B. The first computing device of any of clauses 13B-23B, wherein the first computing device comprises an augmented reality device, an extended reality device, a virtual reality device, or a mobile device.
Clause 25B. A method comprising: receiving, by a second computing device from a first computing device, a first data packet, the first data packet comprising a first time indicator; and transmitting, by the second computing device to the first computing device, a second data packet, the second data packet comprising a second time indicator, a third time indicator, and at least one header extension element, the at least one header extension element comprising a header extension element header, the header extension element header having a length of at least one byte.
Clause 26B. The method of clause 25B, wherein the first time indicator comprises a first timestamp or first delay measurement, wherein the second time indicator comprises a second timestamp or a second delay measurement message and is associated with a receive time of the first data packet, and wherein the third time indicator comprises a third timestamp or a third delay message and is associated with a processing time of the first data packet.
Clause 27B. The method of clause 25B or clause 26B, wherein the at least one header extension element comprises the second time indicator and the third time indicator.
Clause 28B. The method of clause 25B or clause 26B, wherein the at least one header extension element comprises an indication that a payload of the second data packet includes the second time indicator and the third time indicator, wherein the second data packet further comprises the payload, and wherein the payload comprises the second time indicator and the third time indicator.
Clause 29B. The method of any of clauses 25B-28B, wherein the header extension element header comprises an identifier and a length indicator, the length indicator being indicative of the length of the at least one header extension element.
Clause 30B. The method of clause 29B, wherein the identifier comprises information indicative of at least one of a) a number of time indicators contained in the at least one header extension element or the second data packet, or b) the second time indicator and the third time indicator being in a payload of the first data packet.
Clause 31B. The method of clause 29B, wherein the at least one header extension element further comprises a start of the second time indicator, a location of the second time indicator, a length of the second time indicator, or a type of the second time indicator.
Clause 32B. The method of any of clauses 25B-31B, wherein the second data packet is an RTP packet or an SRTP packet.
Clause 33B. The method of any of clauses 25B-31B, wherein a communication path between the first computing device and the second computing device spans a first communication network that is a 5G network and at least one second communication network that is not a 5G network.
Clause 34B. A second computing device, comprising: memory configured to store a first data packet; and one or more processors coupled to the memory, the one or more processors being configured to: receive, from a first computing device, a first data packet, the first data packet comprising a first time indicator; and transmit, to the first computing device, a second data packet, the second data packet comprising a second time indicator, a third time indicator, and at least one header extension element, the at least one header extension element comprising a header extension element header, the header extension element header having a length of at least one byte.
Clause 35B. The method of clause 34B, wherein the first time indicator comprises a first timestamp or first delay measurement, wherein the second time indicator comprises a second timestamp or a second delay measurement message and is associated with a receive time of the first data packet, and wherein the third time indicator comprises a third timestamp or a third delay message and is associated with a processing time of the first data packet.
Clause 36B. The second computing device of clause 34B or clause 35B, wherein the at least one header extension element comprises the second time indicator and the third time indicator.
Clause 37B. The second computing device of clause 34B or clause 35B, wherein the at least one header extension element comprises an indication that a payload of the second data packet includes the second time indicator and the third time indicator, wherein the second data packet further comprises the payload, and wherein the payload comprises the second time indicator and the third time indicator.
Clause 38B. The second computing device of any of clauses 34B-37B, wherein the header extension element header comprises an identifier and a length indicator, the length indicator being indicative of the length of the at least one header extension element.
Clause 39B. The second computing device of clause 38B, wherein the identifier comprises information indicative of at least one of a) a number of time indicators contained in the at least one header extension element or the second data packet, or b) the second time indicator and the third time indicator being in a payload of the first data packet.
Clause 40B. The second computing device of clause 38B, wherein the at least one header extension element further comprises a start of the second time indicator, a location of the second time indicator, a length of the second time indicator, or a type of the second time indicator.
Clause 41B. The second computing device of any of clauses 34B-40B, wherein the second data packet is an RTP packet or an SRTP packet.
Clause 42B. The second computing device of any of clauses 34B-41B, wherein the second time indicator comprises a timestamp or a delay measurement message.
Clause 43B. The second computing device of any of clauses 34B-42B, wherein the second computing device comprises a server.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
transmitting, by a first computing device to a second computing device, a first data packet, the first data packet comprising a first time indicator and at least one header extension element, the at least one header extension element comprising a header extension element header, the header extension element header having a length of at least one byte;
receiving, by the first computing device from the second computing device, a second data packet, the second data packet comprising a second time indicator;
determining, by the first computing device, a data packet delay associated with the first data packet based on the first time indicator and the second time indicator; and
transmitting, by the first computing device, an indication of the data packet delay to at least one of the second computing device or a third computing device.

2. The method of claim 1, wherein at least one header extension element comprises the first time indicator.

3. The method of claim 1, wherein the at least one header extension element comprises an indication that a payload of the first data packet includes the first time indicator, wherein the first data packet further comprises the payload, and wherein the payload comprises the first time indicator.

4. The method of claim 1, wherein the header extension element header comprises an identifier and a length indicator, the length indicator being indicative of the length of the header extension element.

5. The method of claim 4, wherein the identifier comprises information indicative of at least one of a) a number of time indicators contained in the header extension element or the first data packet, or b) the first time indicator being in a payload of the first data packet.

6. The method of claim 4, wherein the header extension element further comprises a start the first time indicator, a location of the first time indicator, a length of the first time indicator, or a type of the first time indicator.

7. The method of claim 1, wherein the first data packet is an RTP packet or an SRTP packet.

8. The method of claim 1, wherein the first time indicator comprises a timestamp or a delay measurement message.

9. The method of claim 1, wherein determining the data packet delay associated with the first data packet comprises determining a one-way transit time of the first data packet based on the first time indicator and the second time indicator.

10. The method of claim 9, further comprising determining a fourth time indicator based on receiving the second data packet,
wherein determining the data packet delay associated with the first data packet comprises:
determining a reverse one-way transit time of the second data packet based on a third time indicator in the second data packet and the fourth time indicator; and
determining the data packet delay by adding the one-way transit time, the reverse one-way transit time.

11. The method of claim 10, wherein determining the data packet delay further comprises:
determining a processing delay based on the second time indicator and the third time indicator; and
determining the data packet delay by further adding the processing delay to the one-way transit time and the reverse one-way transit time.

12. The method of claim 1, wherein a communication path between the first computing device and the second computing device spans a first communication network that is a 5G network and at least one second communication network that is not a 5G network.

13. A first computing device, comprising:
memory configured to store a first data packet; and
one or more processors coupled to the memory, the one or more processors being configured to:
transmit to a second computing device the first data packet, the first data packet comprising a first time indicator and at least one header extension element, the at least one header extension element comprising a header extension element header, the header extension element header having a length of at least one byte;
receive from the second computing device a second data packet, the second data packet comprising a second time indicator;
determine a data packet delay associated with the first data packet based at least in part on at least one of the first time indicator or the second time indicator; and
transmit an indication of the data packet delay to at least one of the second computing device or a third computing device.

14. The first computing device of claim 13, wherein at least one header extension element comprises the first time indicator.

15. The first computing device of claim 13, wherein the at least one header extension element comprises an indication that a payload of the first data packet includes the first time indicator, wherein the first data packet further comprises the payload, and wherein the payload comprises the first time indicator.

16. The first computing device of claim 13, wherein the header extension element header comprises an identifier and a length indicator, the length indicator being indicative of the length of the header extension element.

17. The first computing device of claim 16, wherein the identifier comprises information indicative of at least one of a) a number of time indicators contained in the header extension element or the first data packet, or b) the first time indicator being in a payload of the first data packet.

18. The first computing device of claim 16, wherein the header extension element further comprises a start the first time indicator, a location of the first time indicator, a length of the first time indicator, or a type of the first time indicator.

19. The first computing device of claim 13, wherein the first data packet is an RTP packet or an SRTP packet.

20. The first computing device of claim 13, wherein the first time indicator comprises a timestamp or a delay measurement message.

21. The first computing device of claim 13, wherein as part of determining the data packet delay associated with the first data packet, the one or more processors are configured to determine a one-way transit time of the first data packet based on the first time indicator and the second time indicator.

22. The first computing device of claim 21, wherein the one or more processors are further configured to determine a fourth time indicator based on receiving the second data packet,
wherein as part of determining the data packet delay associated with the first data packet, the one or more processors are further configured to:
determine a one-way transit time of the second data packet based on a third time indicator in the second data packet and the fourth time indicator; and
determine a roundtrip data packet delay by adding the one-way transit time and the reverse one-way transit time.

23. The first computing device of claim 22, wherein as part of determining the data packet delay, the one or more processors are further configured to:
determine a processing delay based on the second time indicator and the third time indicator; and
determine the data packet delay by further adding the processing delay to the one-way transit time and the reverse one-way transit time.

24. The first computing device of claim 13, wherein the first computing device comprises an augmented reality device, an extended reality device, a virtual reality device, or a mobile device.

25. A method comprising:
receiving, by a second computing device from a first computing device, a first data packet, the first data packet comprising a first time indicator; and
transmitting, by the second computing device to the first computing device, a second data packet, the second data packet comprising a second time indicator, a third time indicator, and at least one header extension element, the at least one header extension element comprising a header extension element header, the header extension element header having a length of at least one byte.

26. The method of claim 25, wherein the first time indicator comprises a first timestamp or first delay measurement, wherein the second time indicator comprises a second timestamp or a second delay measurement message and is associated with a receive time of the first data packet, and wherein the third time indicator comprises a third timestamp or a third delay message and is associated with a processing time of the first data packet.

27. The method of claim 25, wherein the at least one header extension element comprises the second time indicator and the third time indicator.

28. The method of claim 25, wherein the at least one header extension element comprises an indication that a payload of the second data packet includes the second time indicator and the third time indicator, wherein the second data packet further comprises the payload, and wherein the payload comprises the second time indicator and the third time indicator.

29. The method of claim 25, wherein the header extension element header comprises an identifier and a length indicator, the length indicator being indicative of the length of the at least one header extension element.

30. The method of claim 29, wherein the identifier comprises information indicative of at least one of a) a number of time indicators contained in the at least one header extension element or the second data packet, or b) the second time indicator and the third time indicator being in a payload of the first data packet.

31. The method of claim 29, wherein the at least one header extension element further comprises a start of the second time indicator, a location of the second time indicator, a length of the second time indicator, or a type of the second time indicator.

32. The method of claim 25, wherein the second data packet is an RTP packet or an SRTP packet.

33. The method of claim 25, wherein a communication path between the first computing device and the second computing device spans a first communication network that is a 5G network and at least one second communication network that is not a 5G network.

34. A second computing device, comprising:
memory configured to store a first data packet; and
one or more processors coupled to the memory, the one or more processors being configured to:
receive, from a first computing device, a first data packet, the first data packet comprising a first time indicator; and
transmit, to the first computing device, a second data packet, the second data packet comprising a second time indicator, a third time indicator, and at least one header extension element, the at least one header extension element comprising a header extension element header, the header extension element header having a length of at least one byte.

35. The method of claim 34, wherein the first time indicator comprises a first timestamp or first delay measurement, wherein the second time indicator comprises a second timestamp or a second delay measurement message and is associated with a receive time of the first data packet, and wherein the third time indicator comprises a third timestamp or a third delay message and is associated with a processing time of the first data packet.

36. The second computing device of claim 34, wherein the at least one header extension element comprises the second time indicator and the third time indicator.

37. The second computing device of claim 34, wherein the at least one header extension element comprises an indication that a payload of the second data packet includes the second time indicator and the third time indicator, wherein the second data packet further comprises the payload, and wherein the payload comprises the second time indicator and the third time indicator.

38. The second computing device of claim 34, wherein the header extension element header comprises an identifier and a length indicator, the length indicator being indicative of the length of the at least one header extension element.

39. The second computing device of claim 38, wherein the identifier comprises information indicative of at least one of a) a number of time indicators contained in the at least one header extension element or the second data packet, or b) the second time indicator and the third time indicator being in a payload of the first data packet.

40. The second computing device of claim 38, wherein the at least one header extension element further comprises a start of the second time indicator, a location of the second time indicator, a length of the second time indicator, or a type of the second time indicator.

41. The second computing device of claim 34, wherein the second data packet is an RTP packet or an SRTP packet.

42. The second computing device of claim 34, wherein the second time indicator comprises a timestamp or a delay measurement message.

43. The second computing device of claim 34, wherein the second computing device comprises a server.
